(19) United States
(12) Patent Application Publication
(10) Pub. No.: US 2020/0310197 A1
(43) Pub. Date: Oct. 1, 2020

(54) BACKLIGHT MODULE AND FIXING STRUCTURE OF BACKLIGHT MODULE

(71) Applicant: HKC CORPORATION LIMITED, Shenzhen , Guangdong (CN)

(72) Inventor: Beizhou HUANG, Chongqing (CN)

(21) Appl. No.: 16/763,293

(22) PCT Filed: Dec. 12, 2017
(86) PCT No.: PCT/CN2017/115641

§ 371 Date: May 12, 2020

(30) Foreign Application Priority Data
Nov. 14, 2017 (CN) 201711118797.5

(51) Int. Cl. G02F 1/13357

(52) U.S. Cl. CPC G02F 1/133608; G02F 1/133605

(57) ABSTRACT

A fixing member for fixing a reflective sheet onto a backpanel includes a first clamping portion, a second clamping portion, a shaft portion, and a buffer pad. The first clamping portion includes a first clamping surface, and the second clamping portion includes a second clamping surface. The shaft portion includes a peripheral side surface and connects between the first and second clamping portions. When the shaft portion is located in the backpanel through hole and the reflective-sheet through hole, the first and second clamping portions are exposed out of the backpanel and the reflective sheet. The first and second clamping portions clamp the reflective sheet and the backpanel. The buffer pad is disposed on the first clamping surface, the second clamping surface and the peripheral side surface. A backlight module including the fixing member is also provided.

### BACKGROUND

### Technical Field

This disclosure relates to a fixing member of a backlight module, and more particularly relates to a fixing member of a backlight module for fixing a reflective sheet on a backpanel.

### Related Art

With the rapid progress of the liquid crystal display (LCD) manufacturing technology, the liquid crystal display has the advantages including the light and thin property, the power-saving property, the radiationless property and the like, and the liquid crystal displays have been widely used in various kinds of electronic products, such as a personal digital assistant (PDA), a notebook computer, a digital camera, a digital camcorder, a mobile phone, a computer screen, a liquid crystal television and the like. However, since the liquid crystal display panel in the liquid crystal display is a non-self-luminous display panel, a light source provided by the backlight module is needed to provide a display function.

In today's increasing design trends of the large-size liquid crystal displays, because the areas of the display panel, the reflective sheet and the backpanel correspondingly become large, the processing engineering of adhering the reflective sheet to the backpanel seems much more difficult, and the uneven concave-convex phenomenon is easily generated after the reflective sheet is adhered to the backpanel. Consequently, the overall luminous quality of the backlight module will be affected to cause the liquid crystal display to easily generate the phenomenon of the uneven frame color (mura).

### SUMMARY

In view of this, an objective of this disclosure is to provide a fixing member of a backlight module to significantly get rid of design trammels that the reflective sheet is conventionally adhered to the backpanel with the adhesive. Not only the adhesive processing engineering can be saved, but also the uneven phenomenon, generated after the conventional reflective sheet is adhered to the backpanel, can be avoided. Consequently, the overall luminous quality of the backlight module can be enhanced, and the liquid crystal display is prevented from generating the phenomenon of the uneven frame color (mura) due to the unevenness of the reflective sheet, thereby quite satisfying the future's design trends of the large-size liquid crystal displays.

This disclosure provides a fixing member of a backlight module for fixing a reflective sheet onto a backpanel. The reflective sheet and the backpanel respectively include a reflective-sheet through hole and a backpanel through hole. The fixing member of the backlight module includes a first clamping portion, a second clamping portion, a shaft portion, and a buffer pad. The first clamping portion includes a first clamping surface, and the second clamping portion includes a second clamping surface facing the first clamping surface. The shaft portion includes a peripheral side surface and connects between the first clamping surface and the second clamping surface. The shaft portion connects between the first clamping portion and the second clamping portion. When the reflective sheet contacts the backpanel with the reflective-sheet through hole and the backpanel through hole correspondingly communicating with each other, and the shaft portion is located in the backpanel through hole and the reflective-sheet through hole, the first clamping portion and the second clamping portion are exposed out of the backpanel and the reflective sheet. The first clamping portion and the second clamping portion clamp the reflective sheet and the backpanel. The buffer pad is disposed on the first clamping surface, the second clamping surface and the peripheral side surface.

In one embodiment, the shaft portion includes a columnar structure.

In one embodiment, the buffer pad contacts surfaces of a portion of the backpanel and a portion of the reflective sheet when the shaft portion is located in the backpanel through hole and the reflective-sheet through hole.

In one embodiment, a height of the shaft portion is smaller than or equal to a sum of a thickness of the reflective sheet and a thickness of the backpanel.

In one embodiment, the first clamping portion, the second clamping portion, and the shaft portion form an I-shaped structure.

In one embodiment, the first clamping portion, the first clamping portion, the second clamping portion, and the shaft portion are a one-piece structure.

In one embodiment, the first clamping portion, the buffer pad includes a buffer surface, and the buffer surface contacts the surfaces of the portion of the backpanel and the portion of the reflective sheet when the shaft portion is located in the backpanel through hole and the reflective-sheet through hole.

The disclosure also provides a fixing member of a backlight module for fixing a reflective sheet onto a backpanel. The reflective sheet and the backpanel respectively includes a reflective-sheet through hole and a backpanel through hole. The fixing member of the backlight module includes a first fixing portion, a second fixing portion, and a shaft portion. The second fixing portion includes a screw hole. The shaft portion connects between the first fixing portion and the second fixing portion. When the shaft portion is located in the backpanel through hole and the reflective-sheet through hole, the first fixing portion and the second fixing portion are exposed out of the backpanel and the reflective sheet. The shaft portion is provided with a thread structure screwed with the screw hole, so that the first fixing portion and the second fixing portion fix the reflective sheet and the backpanel.

In one embodiment, the shaft portion includes a columnar structure.

In one embodiment, the first fixing portion includes a first fixing surface, the second fixing portion includes a second fixing surface facing the first fixing surface, and the first fixing surface and the second fixing surface respectively contact a portion of the backpanel and a portion of the reflective sheet when the shaft portion is located in the backpanel through hole and the reflective-sheet through hole.

In one embodiment, the reflective sheet includes a reflective-sheet top surface, the backpanel includes a backpanel bottom surface opposite to the reflective-sheet top surface, and when the shaft portion is located in the backpanel through hole and the reflective-sheet through hole, the first fixing surface contacts the reflective-sheet top surface and the second fixing surface contacts the backpanel bottom surface.

In one embodiment, the first fixing portion is configured as a cover disposed on the shaft portion to seal the reflective-sheet through hole.

In one embodiment, the cover includes a cover top surface and a cover bottom surface opposite to the cover top surface, the cover bottom surface faces the reflective-sheet top surface, and the cover top surface is a hemispherical structure with an opening facing the cover bottom surface.

In one embodiment, the first fixing portion and the shaft portion are a one-piece structure.

The disclosure further provides a fixing structure of a backlight module including a reflective sheet and a backpanel. Two positioning members are disposed on two sides of the reflective sheet, respectively. The backpanel connects to the reflective sheet. Two engaging portions are disposed on two sides of the backpanel. The positioning members correspondingly snap to the engaging portions, so that the reflective sheet and the backpanel are fixed together.

In one embodiment, the positioning members and the reflective sheet are a one-piece structure.

In one embodiment, the positioning members are protruding members, and the engaging portions are depressed portions.

In one embodiment, the protruding member includes a retractable elastic member, the depressed portion is provided with a groove, and when the reflective sheet and the backpanel are fixed to each other, the retractable elastic member snaps into the groove.

In one embodiment, the reflective sheet is a single transflective sheet.

In one embodiment, a material of the backpanel is a heat-dissipating material.

As mentioned above, the fixing member of the backlight module in this disclosure can overcome the prior art problems by the design of the first clamping portion, the second clamping portion and the shaft portion, so that the reflective sheet is fixed onto the backpanel to enhance the overall luminous quality of the backlight module and prevent the liquid crystal display from generating the phenomenon of the uneven frame color due to the unevenness of the reflective sheet. In addition, by the design of disposing the buffer pad on the first clamping surface, the second clamping surface and the peripheral side surface, it is possible to prevent the reflective sheet and the backpanel from being damaged during clamping and fixing.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1 is a schematic view showing the embodiment of the fixing member of the backlight module of this disclosure.

FIG. 2 is another schematic view showing the embodiment of the fixing member of the backlight module of this disclosure.

FIG. 3 is another schematic view showing the embodiment of the fixing member of the backlight module of this disclosure.

FIG. 4 is another schematic view showing the embodiment of the fixing member of the backlight module of this disclosure.

FIG. 5 is a schematic view showing the embodiment of the fixing structure of the backlight module of this disclosure.

FIG. 6 is another schematic view showing the embodiment of the fixing structure of the backlight module of this disclosure.

### DETAILED DESCRIPTION OF THE DISCLOSURE

Specific structures and function details disclosed herein are only for the illustrative purpose for describing the exemplary embodiment of this disclosure. However, this disclosure can be specifically implemented through many replacements, and should not be explained as being restricted to only the embodiment disclosed herein.

In the description of this disclosure, it is to be understood that the terms “center”, “transversal”, “up,” “down,” “left,” “right,” “vertical”, “horizontal”, “top,” “bottom,” “inside” and “outside” indicating the orientation or position relationships are the orientation or position relationships based on the drawing, are only provided for the purposes of describing this disclosure and simplifying the description, but do not indicate or imply that the directed devices or elements must have the specific orientations or be constructed and operated in the specific orientations, and thus cannot be understood as the restriction to this disclosure. In addition, the terms “first,” and “second” are used for the illustrative purpose only and cannot be understood as indicating or implying the relative importance or implicitly specifying the number of indicated technical features. Therefore, the features restricted by “first” and “second” may expressly or implicitly comprise one or multiple ones of the features. In the description of this disclosure, unless otherwise described, the meaning of “multiple” comprises two or more than two. In addition, the terms “comprises” and any modification thereof intend to cover the non-exclusive inclusions.

In the description of this disclosure, it needs to be described that, unless otherwise expressly stated and limited, the terms “mount,” “link” and “connect” should be broadly understood. For example, they may be the fixed connection, may be the detachable connection or may be the integral connection; may be the mechanical connection or may also be the electrical connection; or may be the direct connection, may be the indirect connection through a middle medium or may be the inner communication between two elements. It will be apparent to those skilled in the art that the specific meanings of the above terms in this application may be understood according to the specific conditions.

The terms used herein are for the purpose of describing only specific embodiments and are not intended to limit the exemplary embodiments. Unless the contexts clearly indicate otherwise, the singular form “one,” “a” and “an” used here further intend to include plural forms. It should also be understood that the terms “comprising” and/or “including” are used herein to describe the features to describe the presence of stated features, integers, steps, operations, units and/or elements without excluding the presence or addition of one or more other features, integers, steps, operations, units, elements, and/or combinations thereof.

The embodiments of the disclosure will be apparent from the following detailed description, which proceeds with reference to the accompanying drawings, wherein the same references relate to the same elements.

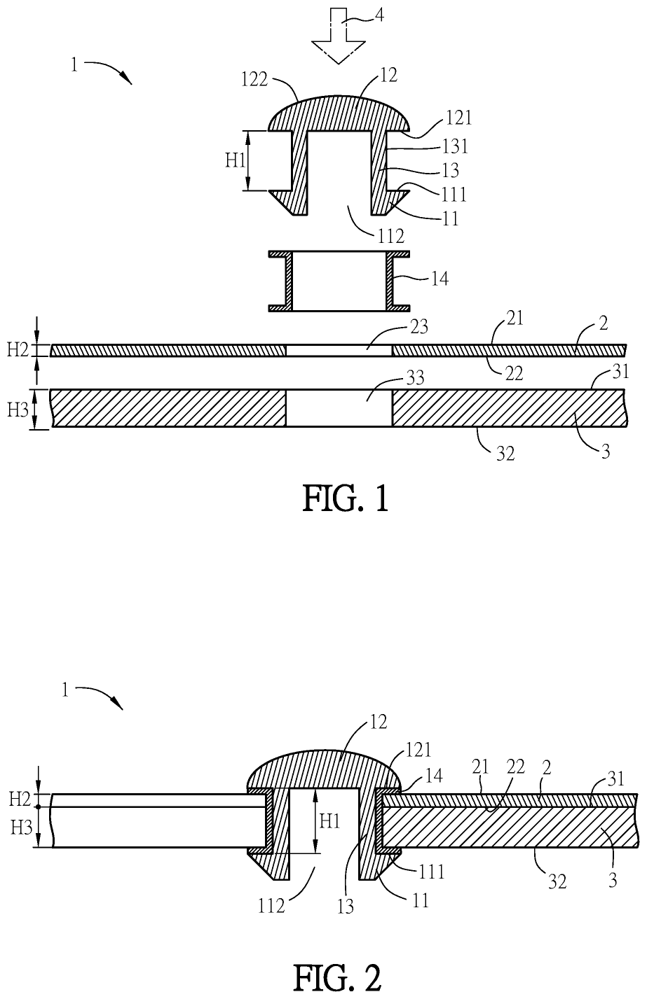

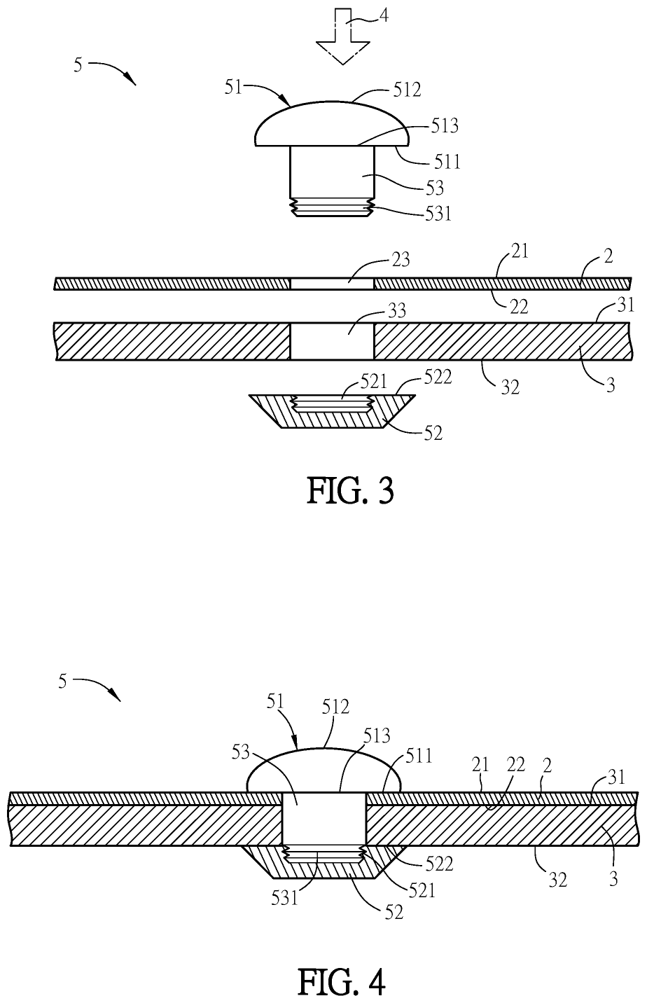

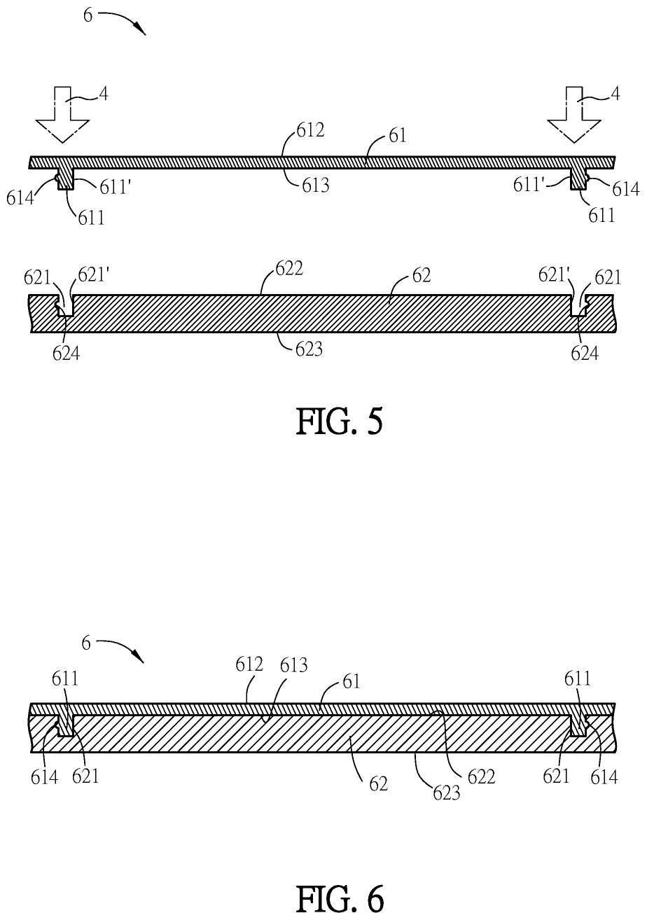

FIG. 1 is a schematic view showing the embodiment of the fixing member of the backlight module of this disclosure. FIG. 2 is another schematic view showing the embodiment of the fixing member of the backlight module of this disclosure. FIG. 3 is another schematic view showing the embodiment of the fixing member of the backlight module of this disclosure. FIG. 4 is another schematic view showing the embodiment of the fixing member of the backlight module of this disclosure. FIG. 5 is a schematic view showing the embodiment of the fixing structure of the backlight module of this disclosure. FIG. 6 is another schematic view showing the embodiment of the fixing structure of the backlight module of this disclosure.

Referring to FIGS. 1 and 2, a fixing member 1 of a backlight module is used to fix a reflective sheet 2 onto a backpanel 3, and significantly gets rid of design trammels that the reflective sheet is conventionally adhered to the backpanel with the adhesive. The reflective sheet 2 includes a reflective-sheet top surface 21 and a reflective-sheet bottom surface 22 opposite to each other, the backpanel 3 includes a backpanel top surface 31 and a backpanel bottom surface 32 opposite to each other. The reflective sheet 2 further includes a reflective-sheet through hole 23 penetrating through the reflective-sheet top surface 21 and the reflective-sheet bottom surface 22, the backpanel 3 further includes a backpanel through hole 33 penetrating through the backpanel top surface 31 and the backpanel bottom surface 32, and an opening size of the reflective-sheet through hole 23 corresponds to an opening size of the backpanel through hole 33.

The fixing member 1 of the backlight module includes a first clamping portion 11, a second clamping portion 12, a shaft portion 13 and a buffer pad 14. The shaft portion 13 connects between the first clamping portion 11 and the second clamping portion 12. The first clamping portion 11 includes a first clamping surface 111, the second clamping portion 12 includes a second clamping surface 121, and the shaft portion 13 includes a peripheral side surface 131. The peripheral side surface 131 connects between the first clamping surface 111 and the second clamping surface 121, and the first clamping surface 111 faces the second clamping surface 121. The shaft portion 13 and the first clamping portion 11 further include a concave hole 112, the concave hole 112 does not penetrate through the second clamping portion 12, and the first clamping portion 11 may be a hook structure bent toward the opening side of the concave hole 112. Because the shaft portion 13 and the first clamping portion 11 include the concave hole 112, the shaft portion 13 and the first clamping portion 11 may be inwardly collapsed to facilitate the user in inserting the shaft portion 13 and the first clamping portion 11 into the reflective-sheet through hole 23 and the backpanel through hole 33. The buffer pad 14 is disposed on the first clamping surface 111, the second clamping surface 121 and the peripheral side surface 131.

As shown in FIG. 1, when the user intends to fix the reflective sheet 2 onto the backpanel 3, the user firstly makes the reflective-sheet bottom surface 22 contact the backpanel top surface 31 in a face-to-face manner with the reflective-sheet through hole 23 and the backpanel through hole 33 correspondingly communicating with each other. Then, the user inserts the shaft portion 13 and the first clamping portion 11 into the reflective-sheet through hole 23 and the backpanel through hole 33 in the direction of an arrow 4 in FIG. 1. Because the concave hole 112 provides a buffer space in which the shaft portion 13 and the first clamping portion 11 may be bent and deformed toward the center of the opening of the concave hole 112, the user easily inserts the shaft portion 13 and the first clamping portion 11 into the reflective-sheet through hole 23 and the backpanel through hole 33. Then, as shown in FIG. 2, when the first clamping portion 11 passes through the reflective-sheet through hole 23 and the backpanel through hole 33, and the shaft portion 13 is located in the backpanel through hole 33 and the reflective-sheet through hole 23, the first clamping portion 11 and the second clamping portion 12 are respectively exposed to the backpanel bottom surface 32 and the reflective-sheet top surface 21. At this time, the buffer pad 14 contacts a portion of the backpanel bottom surface 32 and a portion of the reflective-sheet top surface 21, and the first clamping portion 11 and the second clamping portion 12 clamp the reflective sheet 2 and the backpanel 3 in the top-to-bottom direction to achieve the objective of fixing the reflective sheet 2 onto the backpanel 3.

However, those skilled in the art may also understand that the technology in this embodiment is not limited thereto. For example, the first clamping portion 11, the second clamping portion 12 and the shaft portion 13 is a one-piece structure, just like a dog bone structure or an I-shaped structure. The buffer pad 14 respectively contacts a portion of the backpanel bottom surface 32 and a portion of the reflective-sheet top surface 21 when being located in the backpanel through hole 33 and the reflective-sheet through hole 23. The material of the fixing member 1 of the backlight module may be the transparent acrylic (poly methylmethacrylate, PMMA) or white material, and the material of the buffer pad 14 is a plastic material, such as rubber. In addition, a height H1 of the shaft portion 13 is equal to or slightly smaller than a sum of a thickness H2 of the reflective sheet 2 and a thickness H3 of the backpanel 3. In addition, the peripheral shape of any cross-section of the shaft portion 13 with the arrow 4 serving as the normal direction corresponds to an opening shape of the reflective-sheet through hole 23 and an opening shape of the backpanel through hole 33. When both the opening shape of the reflective-sheet through hole 23 and the opening shape of the backpanel through hole 33 are circular, the peripheral shape of any cross-section of the shaft portion 13 with the arrow 4 serving as the normal direction is also circular. In this embodiment, the second clamping portion 12 further includes a clamping-portion top surface 122 disposed opposite and connected to the second clamping surface 121, the clamping-portion top surface 122 is a bowl surface or hemispherical surface with an opening facing the second clamping surface 121. That is, the second clamping portion 12 is an upside down bowl-shaped structure or an upper hemisphere structure.

As can be seen from FIGS. 1 and 2, the fixing member 1 of the backlight module in this disclosure can overcome the prior art problems by the design of the first clamping portion 11, the second clamping portion 12 and the shaft portion 13, so that the reflective sheet 2 is fixed onto the backpanel 3 to enhance the overall luminous quality of the backlight module and prevent the liquid crystal display from generating the phenomenon of the uneven frame color due to the unevenness of the reflective sheet 2. In addition, by the design of disposing the buffer pad 14 on the first clamping surface 111, the second clamping surface 121 and the peripheral side surface 131, it is possible to prevent the reflective sheet 2 and the backpanel 3 from being damaged during clamping and fixing.

Referring to FIGS. 3 and 4, a fixing member 5 of the backlight module is used to fix the reflective sheet 2 onto the backpanel 3, and significantly gets rid of design trammels that the reflective sheet is conventionally adhered to the backpanel with the adhesive. The structure and arrangement of the reflective sheet 2 and the backpanel 3 are the same as those previously mentioned, and detailed descriptions thereof will be omitted.

The fixing member 5 of the backlight module includes a first fixing portion 51, a second fixing portion 52 and a shaft portion 53. The shaft portion 53 connects between the first fixing portion 51 and the second fixing portion 52. The second fixing portion 52 includes a screw hole 521. When the shaft portion 53 is located in the backpanel through hole 33 and the reflective-sheet through hole 23, the first fixing portion 51 and the second fixing portion 52 are exposed out of the reflective sheet 2 and the backpanel 3, and the shaft portion 53 is provided with a thread structure 531 screwed with the screw hole 521, so that the first fixing portion 51 and the second fixing portion 52 fix the reflective sheet 2 and the backpanel 3. The first fixing portion 51 may be configured as a cover to seal the reflective-sheet through hole 23. The cover includes a cover top surface 512 and a cover bottom surface 513 opposite to the cover top surface 512, the cover bottom surface 513 faces the reflective-sheet top surface 21, and the cover top surface 512 is a hemispherical structure with an opening facing the cover bottom surface 513.

As shown in FIG. 3, when the user intends to fix the reflective sheet 2 onto the backpanel 3, the user firstly makes the reflective-sheet bottom surface 22 contact the backpanel top surface 31 in a face-to-face manner with the reflective-sheet through hole 23 and the backpanel through hole 33 correspondingly communicating with each other. Then, the user inserts the shaft portion 53 and the first fixing portion 51 into the reflective-sheet through hole 23 and the backpanel through hole 33 in the direction of an arrow 4 in FIG. 3. Then, as shown in FIG. 4, when the first fixing portion 51 passes through the reflective-sheet through hole 23 and the backpanel through hole 33, and the shaft portion 53 is located in the backpanel through hole 33 and the reflective-sheet through hole 23, the first fixing portion 51 and the second fixing portion 52 are respectively exposed to the backpanel bottom surface 32 and the reflective-sheet top surface 21. At this time, because the shaft portion 53 is provided with the thread structure 531, the second fixing portion 52 includes the screw hole 521, and the screw hole 521 and the thread structure 531 are screwed with each other, so that the first fixing portion 51 and the second fixing portion 52 fix the reflective sheet 2 and the backpanel 3.

Those skilled persons in the art should understand that the technology of this embodiment is not limited to the above description. For example, the first fixing portion 51 and the shaft portion 53 can be a one-piece structure. The first fixing portion 51 includes a first fixing surface 511, the second fixing portion 52 includes a second fixing surface 522 facing the first fixing surface 511, and the first fixing surface 511 and the second fixing surface 522 respectively contact a portion of the backpanel bottom surface 32 and a portion of the reflective-sheet top surface 21 when the shaft portion 53 is located in the backpanel through hole 33 and the reflective-sheet through hole 23. The material of the fixing member 5 of the backlight module can include PMMA or a white material.

As can be seen from FIGS. 3 and 4, the fixing member 5 of the backlight module in this disclosure can overcome the prior art problems by the design of the first fixing portion 51, the second fixing portion 52 and the shaft portion 53, so that the reflective sheet 2 is fixed onto the backpanel 3 to enhance the overall luminous quality of the backlight module and prevent the liquid crystal display from generating the phenomenon of the uneven frame color due to the unevenness of the reflective sheet 2. The second fixing portion 52 includes the screw hole 521, and the shaft portion 53 is provided with the thread structure 531 screwed with the screw hole 521. By the design of fixing the thread structure 531 to the screw hole 521 using the screwing method, the screwing tightness can be controlled, and it is possible to prevent the reflective sheet 2 and the backpanel 3 from being damaged due to the uneven fixing force.

Referring to FIGS. 5 and 6, a fixing structure 6 of the backlight module includes a reflective sheet 61 and a backpanel 62. The reflective sheet 61 includes a reflective-sheet top surface 612 and a reflective-sheet bottom surface 613 opposite to each other, and the backpanel 62 includes a backpanel top surface 622 and a backpanel bottom surface 623 opposite to each other. Two positioning members 611 are disposed on two sides of the reflective-sheet bottom surface 613, respectively. The backpanel 62 is connected to the reflective sheet 61, two engaging portions 621 are disposed on two sides of the backpanel top surface 622, and the positioning member 611 correspondingly snaps to the engaging portion 621, so that the reflective sheet 61 and the backpanel 62 are fixed together.

As shown in FIG. 5, when the user wants to fix the reflective sheet 61 onto the backpanel 62, the user firstly makes the reflective-sheet bottom surface 613 contact with the backpanel top surface 622 in the face-to-face manner. Then, the user inserts the positioning member 611 into the engaging portion 621 in the direction of an arrow 4 in FIG. 5. At this time, the positioning member 611 correspondingly snaps to the engaging portion 621 to achieve the objective of fixing the reflective sheet 61 and the backpanel 62 each other.

Those skilled persons in the art should understand that the technology of this embodiment is not limited to the above description. For example, the positioning member 611 and the reflective sheet 61 can be a one-piece structure. The positioning member 611 is a protruding member 611′, and the engaging portion 621 is a depressed portion 621′; the protruding member 611′ includes a retractable elastic member 614, and the depressed portion 621′ is provided with a groove 624. When the reflective sheet 61 and the backpanel 62 are fixed to each other, the retractable elastic member 614 snaps into the groove 624; the reflective sheet 61 is a single transflective sheet; and the material of the backpanel 62 is a heat-dissipating material (such as the aluminum material) to increase the heat dissipating way of the backlight module, thereby enhancing the heat dissipation efficiency.

As can be seen from FIGS. 5 and 6, the fixing structure 6 of the backlight module in this disclosure can overcome the prior art problems by respectively disposing the two positioning members 611 on the two sides of the reflective sheet 61, disposing the two engaging portions 621 on the two sides of the backpanel 62, and correspondingly snapping the positioning member 611 to the engaging portion 621, so that the reflective sheet 61 and the backpanel 62 are fixed to each other to enhance the overall luminous quality of the backlight module and to prevent the liquid crystal display from generating the phenomenon of uneven frame color due to the unevenness of the reflective sheet.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A fixing member of a backlight module for fixing a reflective sheet onto a backpanel, wherein the reflective sheet and the backpanel respectively include a reflective-sheet through hole and a backpanel through hole, and the fixing member of the backlight module comprises:
a first clamping portion and a second clamping portion, wherein the first clamping portion includes a first clamping surface, and the second clamping portion includes a second clamping surface facing the first clamping surface;
a shaft portion including a peripheral side surface and connecting between the first clamping surface and the second clamping surface, wherein the shaft portion connects between the first clamping portion and the second clamping portion, wherein when the reflective sheet contacts the backpanel with the reflective-sheet through hole and the backpanel through hole correspondingly communicating with each other, and the shaft portion is located in the backpanel through hole and the reflective-sheet through hole, the first clamping portion and the second clamping portion are exposed out of the backpanel and the reflective sheet, and the first clamping portion and the second clamping portion clamp the reflective sheet and the backpanel; and
a buffer pad disposed on the first clamping surface, the second clamping surface and the peripheral side surface.

2. The fixing member of the backlight module according to claim 1, wherein the shaft portion includes a columnar structure.

3. The fixing member of the backlight module according to claim 2, wherein the buffer pad contacts surfaces of a portion of the backpanel and a portion of the reflective sheet when the shaft portion is located in the backpanel through hole and the reflective-sheet through hole.

4. The fixing member of the backlight module according to claim 1, wherein a height of the shaft portion is smaller than or equal to a sum of a thickness of the reflective sheet and a thickness of the backpanel.

5. The fixing member of the backlight module according to claim 1, wherein the first clamping portion, the second clamping portion, and the shaft portion form an I-shaped structure.

6. The fixing member of the backlight module according to claim 1, wherein the first clamping portion, the second clamping portion, and the shaft portion are a one-piece structure.

7. The fixing member of the backlight module according to claim 3, wherein the buffer pad includes a buffer surface, and the buffer surface contacts the surfaces of the portion of the backpanel and the portion of the reflective sheet when the shaft portion is located in the backpanel through hole and the reflective-sheet through hole.

8. A fixing member of a backlight module for fixing a reflective sheet onto a backpanel, wherein the reflective sheet and the backpanel respectively include a reflective-sheet through hole and a backpanel through hole, and the fixing member of the backlight module comprises:
a first clamping portion and a second clamping portion, wherein the first clamping portion includes a first clamping surface, and the second clamping portion includes a second clamping surface facing the first clamping surface;
a shaft portion including a columnar structure, wherein the shaft portion includes a peripheral side surface and connects between the first clamping surface and the second clamping surface, the shaft portion connects between the first clamping portion and the second clamping portion, wherein when the reflective sheet contacts the backpanel with the reflective-sheet through hole and the backpanel through hole correspondingly communicating with each other, and the shaft portion is located in the backpanel through hole and the reflective-sheet through hole, the first clamping portion and the second clamping portion are exposed out of the backpanel and the reflective sheet, the first clamping portion and the second clamping portion clamp the reflective sheet and the backpanel, and a height of the shaft portion is smaller than or equal to a sum of a thickness of the reflective sheet and a thickness of the backpanel; and
a buffer pad disposed on the first clamping surface, the second clamping surface and the peripheral side surface.

9. The fixing member of the backlight module according to claim 8, wherein the buffer pad contacts surfaces of a portion of the backpanel and a portion of the reflective sheet when the shaft portion is located in the backpanel through hole and the reflective-sheet through hole.

10. The fixing member of the backlight module according to claim 9, wherein the buffer pad includes a buffer surface, and the buffer surface contacts the surfaces of the portion of the backpanel and the portion of the reflective sheet when the shaft portion is located in the backpanel through hole and the reflective-sheet through hole.

11. The fixing member of the backlight module according to claim 8, wherein the first clamping portion, the second clamping portion, and the shaft portion form an I-shaped structure.

12. The fixing member of the backlight module according to claim 8, wherein the first clamping portion, the second clamping portion, and the shaft portion are a one-piece structure.

13. A backlight module, comprising:
a backpanel including a backpanel through hole;
a reflective sheet disposed on the backpanel, wherein the reflective sheet includes a reflective-sheet through hole; and
a fixing member for fixing the reflective sheet on the backpanel, wherein the fixing member comprises:
a first clamping portion and a second clamping portion, wherein the first clamping portion includes a first clamping surface, and the second clamping portion includes a second clamping surface facing the first clamping surface;
a shaft portion including a peripheral side surface and connecting between the first clamping surface and the second clamping surface, wherein the shaft portion connects between the first clamping portion and the second clamping portion, wherein when the reflective sheet contacts the backpanel with the reflective-sheet through hole and the backpanel through hole correspondingly communicating with each other, and the shaft portion is located in the backpanel through hole and the reflective-sheet through hole, the first clamping portion and the second clamping portion are exposed out of the backpanel and the reflective sheet, and the first clamping portion and the second clamping portion clamp the reflective sheet and the backpanel; and
a buffer pad disposed on the first clamping surface, the second clamping surface and the peripheral side surface.

14. The backlight module according to claim 13, wherein the shaft portion includes a columnar structure.

15. The backlight module according to claim 14, wherein the buffer pad contacts surfaces of a portion of the backpanel and a portion of the reflective sheet when the shaft portion is located in the backpanel through hole and the reflective-sheet through hole.

16. The backlight module according to claim 13, wherein a height of the shaft portion is smaller than or equal to a sum of a thickness of the reflective sheet and a thickness of the backpanel.

17. The backlight module according to claim 13, wherein the first clamping portion, the second clamping portion, and the shaft portion form an I-shaped structure.

18. The backlight module according to claim 13, wherein the first clamping portion, the second clamping portion, and the shaft portion are a one-piece structure.

19. The backlight module according to claim 15, wherein the buffer pad includes a buffer surface, and the buffer surface contacts the surfaces of the portion of the backpanel and the portion of the reflective sheet when the shaft portion is located in the backpanel through hole and the reflective-sheet through hole.
